(19) United States
(12) Patent Application Publication
(10) Pub. No.: US 2007/0239539 A1
(43) Pub. Date: Oct. 11, 2007

(54) Method and device for providing and choosing hair accessories based on hair color

(75) Inventors: Lisa C. King, Atlanta, GA (US); Deborah Rubin, Atlanta, GA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: GOODY PRODUCTS, INC., Freeport, IL (US)

(21) Appl. No.: 11/402,175

(22) Filed: Apr. 11, 2006

(51) Int. Cl. G07G 1/14; G06Q 30/00

(52) U.S. Cl. 705/14

(57) ABSTRACT

A system for choosing hair accessories includes a first set of hair accessories and a second set of hair accessories. Each of the first set of hair accessories are of a different type and have a first color that is matched to a first hair color. Each of the second set of hair accessories are of a different type and have a second color that is matched to a second hair color. The first and second sets each include a similar assortment of accessories.

### TECHNICAL FIELD

The present disclosure relates generally to hair accessories and, more particularly, to a method and device for choosing and providing hair accessories based on hair color.

### BACKGROUND OF THE DISCLOSURE

Hair accessories such as hair bands, hair clips, barrettes, ponytail holders, claw clips, and bobby pins have been utilized for many years in shaping and holding a user's hair. These and other hair accessories are available in various colors. For example, hair bands generally come in common colors such as black, gray, white, etc. or include patterns and motifs depending on the fabric used and the desired style of the product. Similarly, ponytail holders and barrettes are available in various colors and styles, which may depend on the anticipated appeal to the target customer, material used, and other factors related to the manufacturing and marketing of the products.

Given the variety of products and colors, users may purchase hair accessories based on the type of hair accessory they wish to utilize, or may purchase hair accessories based on the color they wish the hair accessory to have. However, not all hair accessories are available in all colors, leaving the consumer to settle for purchasing products that may not be the optimal color, or type of hair accessory they would prefer to purchase. This is especially evident when a user attempts to purchase a particular type of hair accessory to match the user's hair color.

For example, a user with blonde hair wishing to purchase a claw clip that matches the user's hair may find claw clips that are black or brown in color or may have a multicolor design, but not a claw clip that is blonde in color. In contrast, the user may find a barrette of a blonde color, but the barrette may not be suited for the purpose intended by the user. Accordingly, there is a need to provide a variety of hair accessories that all have the same color and, in particular, that have colors that are matched to the colors generally worn by users or matched to the user's hair colors such that the accessories blend in with the user's hair when the accessories are worn.

### BRIEF DESCRIPTION OF THE DRAWINGS

FIG. 1 is a front view of a display configuration for sets of hair accessories in a display area;

FIG. 2 is a front view of an alternative display configuration for sets of hair accessories in a display area;

FIG. 3 is a front view of hair accessories on a display package having a colored backing;

FIG. 4 is a front view of hair accessories on a display package having a colored backing, similar to FIG. 3;

FIG. 5 is a front view of hair accessories on a display package having a colored backing, similar to FIG. 3;

FIG. 6 is an isometric view of a hair accessories display area including a hair accessories selection device and a reflective surface;

FIG. 7 is an isometric view of a dyeable hair accessory;

FIG. 8 is an isometric view of a claw clip with colorable inserts; and

FIG. 9 is an isometric view of a claw clip with a colorable cover.

While the method and device described herein are susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the disclosure and the claims.

### DETAILED DESCRIPTION

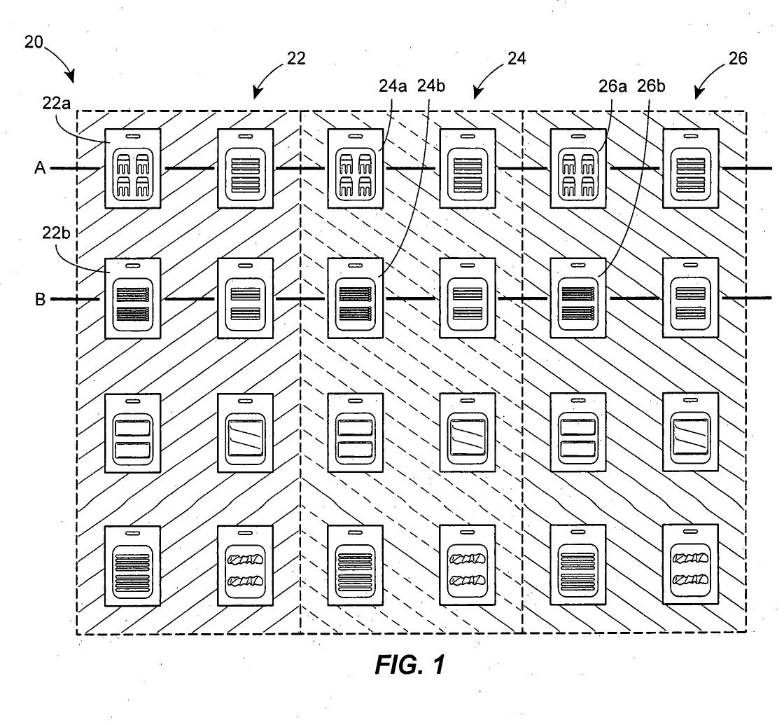

Referring now to the drawings, and with specific reference to FIG. 1, a hair accessories system in accordance with the teachings of the disclosure is generally depicted by reference numeral 20. As shown therein, the system 20 includes a first set of hair accessories 22, a second set of hair accessories 24, and a third set of hair accessories 26. The system 20 may include additional sets of hair accessories, such as a fourth set, a fifth set, etc. However, for the sake of brevity, the system 20 is described herein with reference to illustrated sets 22, 24 and 26.

The sets 22, 24 and 26 each include various types of hair accessories. For example, the first set 22 may include, but is not limited to, hair bands, head bands, head scarves, hair rollers, hair curlers, hair combs, hair clips, barrettes, bobby slides, ponytail holders/elastic bands, contour clips, fabric covered elastic bands, claw clips, and bobby pins. The term “elastics” or “elastic bands” may include, but is not limited to, braided elastics, fabric covered elastics, charmed elastics, latex elastics, twin-bead elastics, ribbon elastics, terry-o elastics, and woven cut band elastics. Furthermore, within each of the various types of hair accessories there may various sub-types. For example, a claw clip—one type of hair accessory—may include, mini-claw clips, heavy-duty claw clips, etc. The sets 24 and 26 may include similar arrays of hair accessories.

The sets 22, 24 and 26 are each defined by different colors such that all of the various types of hair accessories in each set have the same color. In particular, the colors of each of the sets may be matched or particularly chosen to match a hair color or common hair colors generally worn by users. For example, the colors may be chosen to match or closely match blonde, brown, light brown, red, auburn, black, etc. In addition, the colors may be chosen to match or closely match one or more of the above mentioned hair colors with additional color features or hair treatments such as, for example, highlights, lowlights, chunky highlight, shine glaze, etc. For example, a secondary color may be added to the hair accessory in the form of streaks or lines to represent highlights or lowlights. The hair accessories, however, may be modified and altered in a variety of ways in order to achieve the appropriate color and the look of having the additional color feature or hair treatment, which may be completed during a primary or secondary process. For example, the hair accessories may be painted with stripes, streaks or other pattern, coated, pearlized, marbleized, overmolded, inlayed, include glitter, etc.

In another exemplary embodiment, the colors of the sets may be matched to existing hair dye colors that are commercially available. As such, a user could color her hair a certain color, and then purchase hair accessories of that same color such that the accessories blend in with the user's hair. For example, commercially available hair coloring kits are provided by among others, Loreal™, Clairol™, and Garnier™, and include a large array of colors such as medium ash blonde, light gold brown, etc. In this way, a full range of accessories may be provided for each hair color to which a set of accessories is matched.

The colors to which the sets of hair accessories 22, 24 and 26 are matched may be chosen in a variety of ways. In one exemplary embodiment, the various hair colors worn by user may be placed into several categories. For example, the categories may include blonde, brown, black, red, grey, etc. These categories may then be further broken down into shades of colors. For example, blonde may include beach and butterscotch, brown may include truffle and cocoa, red may include cooper and cinnamon, black may include sable and onyx, etc. Once the categories and the shades are established, the colors to be used may be determined by which category, shade or shades within the category is most commonly worn by consumers. Alternatively, the colors may be chosen by which color is most popular, easy to color match, cost effectively to manufacture, etc.

Now referring again to FIG. 1, the sets of hair accessories 22, 24 and 26 may be displayed in a display area that is provided along with the sets of hair accessories 22, 24 and 26, but in most instances will be displayed in existing display space installed at the sellers location. In either display, the sets of hair accessories 22, 24, 26 may be displayed together as a collection, such that the sets of hair accessories 22, 24, 26 stand out from other hair accessories offered by the same or other manufacturers that are not part of the collection. In doing so, the sets of hair accessories 22, 24, 26 may be displayed in sections such that each section corresponds to or is defined by the color of the corresponding set. In addition, as illustrated in FIG. 1, each of the sections may be defined with a color that corresponds to the set disposed in that section. For example, a background of the section that corresponds to a set of brown hair accessories may be colored brown. In doing so, it is easily discernible where the various sets of accessories are on the display area.

The sections may then be arranged relative to each other to provide various merchandizing goals. For example, as illustrated in FIG. 1, the sections may be configured in a vertical orientation, such that the sections are more elongate in the vertical direction than in the horizontal direction. In this arrangement, the sections are oriented side-by-side. When in this vertical orientation, the same types of hair accessories within the sections may be aligned or arranged along the same horizontal axis. For example, the first set of hair accessories may include claw clips 22a, bobby pins 22b, etc. in the color of the first set 22 and the second set of hair accessories may include claw clips 24a, bobby pins 24b, etc. in the color of the second set 24. Therefore, when the sections are arranged side-by-side, the claw clips 22a, 24a may be arranged along a first horizontal axis A and the bobby pins 22b, 24b may be arranged along a second horizontal axis B, such that each accessory is disposed in a consistent location within the section of each set 22, 24, 26.

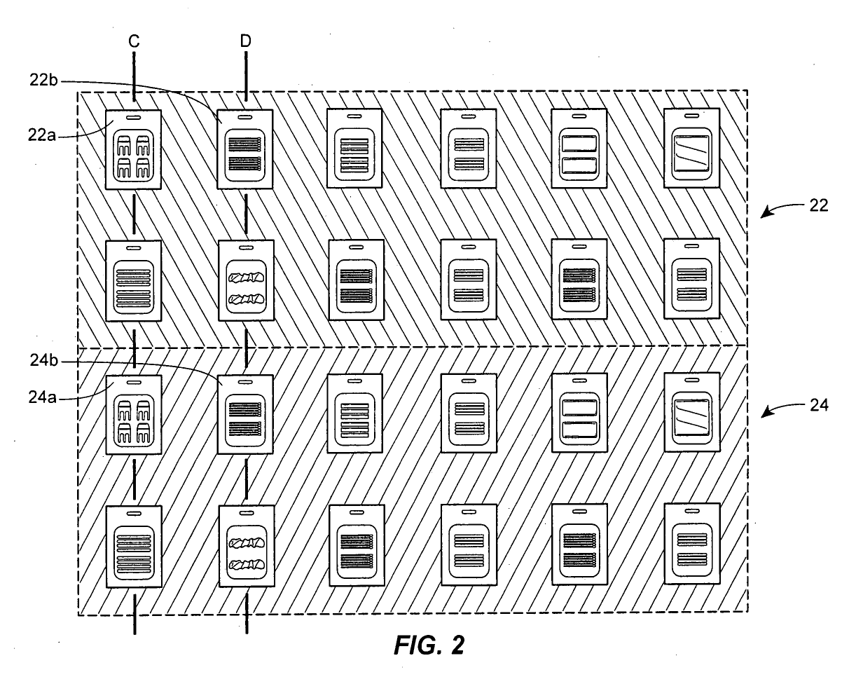

Alternatively, as illustrated in FIG. 2, the sections may be configured in a horizontal orientation, such that the sections are more elongate in the horizontal direction than in the vertical direction. In this arrangement, the sections are oriented one over the other. When in this horizontal orientation, similar hair accessories within the sections may be aligned or arranged along a vertical axis, such that each accessory is disposed in a consistent location within the display of each set 22, 24. For example, the claw clips 22a, 24a may be arranged along a first vertical axis C and the bobby pins 22b, 24b may be arranged along a second vertical axis D.

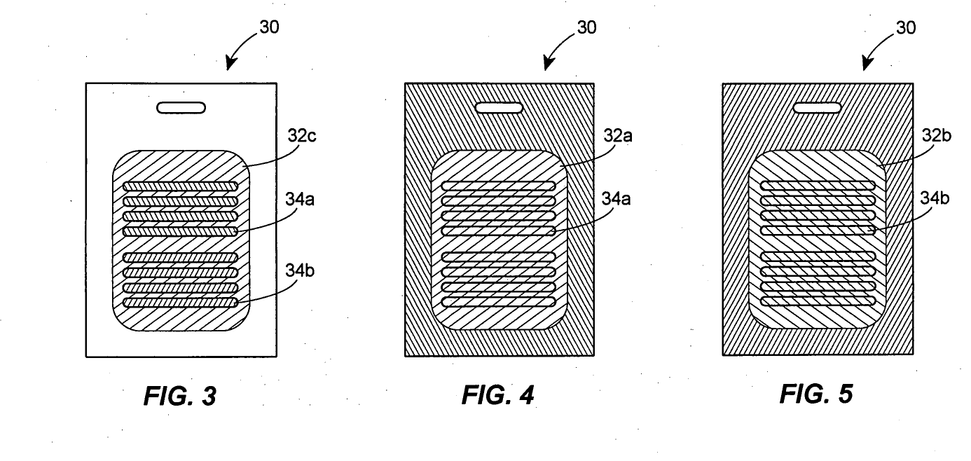

Referring now to FIGS. 3, 4 and 5, the hair accessories may be provided with packaging such as a backing or backboard 30 that may be provided in any variety of shapes and sizes, and may include additional packaging components, such as a plastic casing, shrink wrap, blister packaging, a box, or other container, a reinforcement ring and the like (all not shown). Each of the hair accessories preferably includes some shape or form of backing 30 to which the hair accessory is attached or within which the hair accessory is encased. In the illustrated example, the backing 30 may be colored or may include a colored area 32 having a color corresponding to the color of the hair accessory to which it is attached or corresponding to the set 22, 24, 26 of which the hair accessory is a part. As such, each of the respective sections not only have the same color hair accessories, but also have the same color backing. Thus, the colored area 32 may be used to identify a set of hair accessories or, as explained in more detail below, may also be used to identify a shade and/or a color category. In one exemplary embodiment, all of the hair accessories of the same color category may have the same color backing, but in an alternate embodiment, the color of the backing may change depending on the shade within that category and/or the feature within that category. For example, the blonde hair accessories may be elastic bands 34 that come in two different shades of blonde—beach (a) and butterscotch (b). (The alpha identifiers in FIGS. 3, 4 and 5 are each representative of a different color, whether it be a shade of color, a category of color, etc.) In the first example, the backing 30 includes beach elastic bands 34a and butterscotch elastic bands 34b, and has a blonde colored area 32c, which may be a generic blonde or other blonde color (FIG. 3). In contrast, in the second example the beach colored elastic bands 34a are disposed on a beach colored area 32a (FIG. 4) and the butterscotch elastic bands 34b are disposed on a butterscotch colored area 32b (FIG. 5).

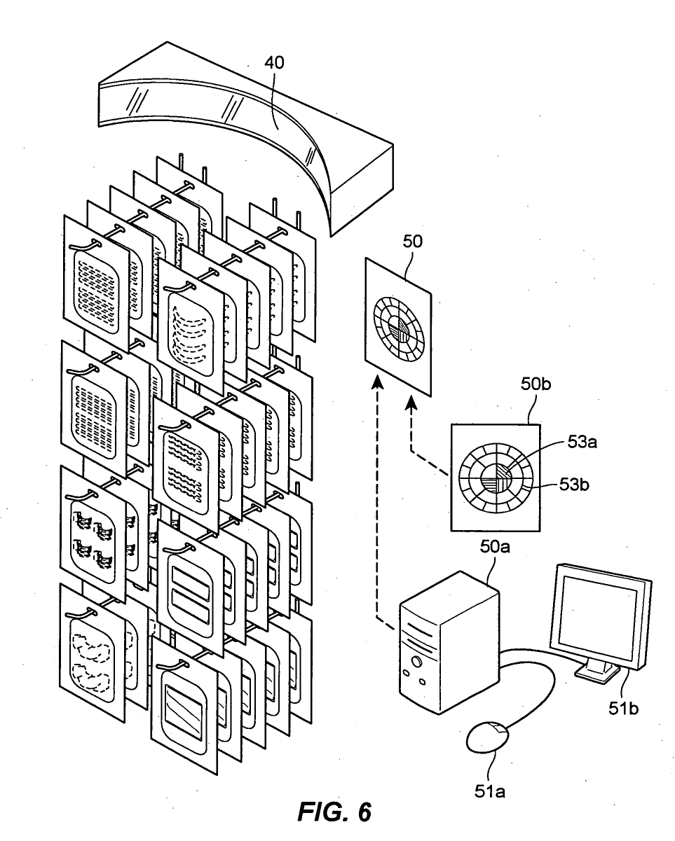

Referring now to FIG. 6, the display (depicting only one set of hair accessories) may include additional components including a reflective surface 40 and a hair accessories selection device 50. The reflective surface 40 may be any type of surface that allows the user to view her hair or hair color, and may be mounted adjacent the display, the sections or the sets of accessories. As illustrated in FIG. 6, the reflective surface may be a mirror disposed along the display area. The reflective surface 40 may have a variety of shapes, including a concave shape such that a user can more easily view her hair or hair accessories.

The hair accessories selection device 50 may be used to aid the customer in choosing the proper color and/or type of hair accessory. For example, the hair accessories selection device 50 may be a programmable controller or computer 50a workable via a keyboard, mouse 51a, touchscreen 51b, or the like, a color wheel 50b, a color chart, or other device able to receive an input and able to provide an output. For example, in using the accessories selection device 50a, the customer may begin the hair accessory selection process by identifying the color of the customer's hair. This may be done by comparing the customer's hair to colors displayed on the selection device 50a and then choosing the best color match on the selection device 50a. Alternatively, the customer may be required to make additional choices in selecting the best color match. For example, instead of simply choosing the best color match on the selection device 50a, the customer may go through several steps such as first choosing a hair category, such as blonde, and then choosing a shade within that category, such as beach.

Based on the color selected, the selection device 50a will provide the color of hair accessories that most closely matches the user's hair color. The selection process may further include selection by the customer of the type of look the customer desires. The type of look may be characterized as casual, dramatic, professional, or the like. Based on the information provided, the selection device 50a will select/suggest a list of hair accessories, all of which are of the same color, that are best suited for the customer's hair color and desired look.

The same or similar results may be obtained with the color wheel 50b. The color wheel 50b may include one or more wheels able to spin relative to each other about a single axis. In particular, a first or inner wheel 53a may include a range of hair colors disposed radially about the inner wheel 53a such that the customer can select the hair color that best matches her own hair color. Once the best matched hair color is chosen, the color wheel 50b will determine the color of hair accessory that best matched that hair color. This may all be accomplished on the inner wheel 53a. A second or outer wheel 53b may include various looks disposed radially about the outer wheel 53b such the customer may rotate the wheels 53a, 53b relative to each other, to align the color of hair accessory with the type of look desired. As a result, the color wheel 50b will suggest a list of hair accessories, which may be disposed on the outer wheel 53b, that are best suited for the customer's hair color and desired look.

For example, the customer may chose her hair color—dirty blonde—from a plurality of different hair colors on the inner wheel 53a. Accordingly, the color wheel 50b may identify the butterscotch colored hair accessories as the best color match. The customer may then choose to have a casual look. By aligning the butterscotch color on the inner wheel 53a with a causal look on the outer wheel 53b, the color wheel 50b may suggest using a butterscotch colored elastic band or fabric covered elastic band. In contrast, if the user chose to have a professional look, to color wheel 50b may suggest a butterscotch colored bobby slide or barrette, for example.

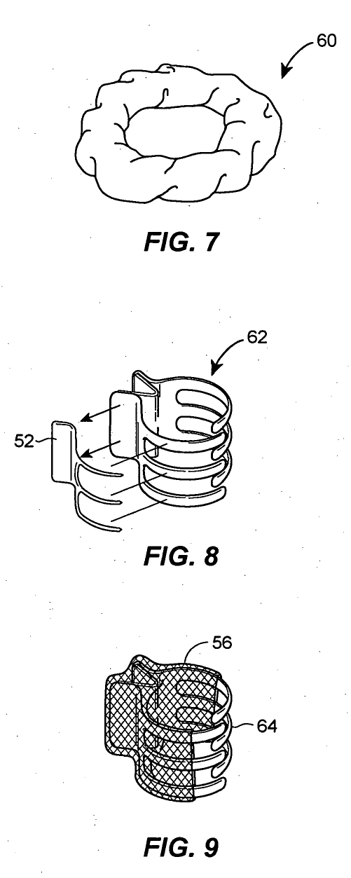

The above embodiments may be varied to achieve and/or create additional or alternative features. For example, the hair accessories may be dyeable, colorable or paintable. For example, as illustrated in FIG. 7, a fabric covered elastic band 60 may be constructed from a dyeable or colorable material. In this example, the user can dye the fabric covered elastic band 60 with the same coloring used to dye her hair, such that the hair and the hair accessory have essentially the same color. In one example, the hair coloring may be provided with the colorable hair accessory such that user can chose the type of hair accessory or accessories she wishes to purchase, and can then choose an adjacently provided color. Alternatively, the user may chose a hair color provided by another manufacturer.

In another embodiment, as illustrated in FIGS. 8 and 9, the hair accessories may themselves not be colorable, but are able to receive colorable inserts 52 (FIG. 8) or be covered by a colored or colorable covering 56 (FIG. 9). In particular, a claw clip 62, which once again is representatives of the other hair accessories, may include one or more inserts 52 disposed on various portions of the claw clip 62 such that the color of the claw clip 62 may be altered with the inserts 52 to match the user's hair color. The inserts 52 may be provided in various colors corresponding to the sets of colors, such that the user would simply purchase or place the desired color insert 52 into the hair accessory. Alternatively, the insert 52 may be colored or colorable using any of the above mentioned techniques and methods.

Referring now to FIG. 9, a representative claw clip 64 is illustrated with a cover 56. The cover 56 may be provided in various colors corresponding to the sets of colors, such that the user would simply purchase or place the desired color cover 56 over the hair accessory 64, or the cover 56 may be colored or colorable using any of the above mentioned techniques and methods.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A method of merchandising hair accessories, comprising:
providing a first set of hair accessories, wherein each of the first set of hair accessories has a first color matched to a first hair color;
providing a second set of hair accessories, wherein each of the second set of hair accessories has a second color matched to a second hair color, the first color being different from the second color; and
displaying the first set of hair accessories in a first section and the second set of hair accessories in a second section, wherein the first section is adjacent to and separate from the second section.

2. The method of claim 1, wherein displaying further includes arranging the first section and the second section such that the first and second sections are disposed side-by-side.

3. The method of claim 1, wherein similar type of accessories are displayed in substantially the same locations within corresponding display sections.

4. The method of claim 1, wherein the assortment of accessories in the first set is similar to the assortment of accessories in the second set.

5. The method of claim 3, wherein the first and second sections are arranged side-by-side such that similar types of accessories are disposed on a common axis.

6. The method of claim 5, wherein first corresponding types of hair accessory of the first and second set are disposed along a first horizontal axis.

7. The method of claim 6, wherein second corresponding types of hair accessory of the first and second set are disposed along a second axis.

8. The method of claim 7, wherein the first and the second axes are parallel to each other.

9. The method of claim 3, wherein displaying further includes arranging the first section and the second section such that the first section is disposed above the second section.

10. The method of claim 9, wherein corresponding types of hair accessories of the first and second sets are vertically aligned.

11. The method of claim 1, further including providing a reflective surface adjacent at least one of the first and second sections to allow a customer to view their own hair.

12. The method of claim 1, further including providing a hair accessory selection device adjacent at least one of the first and second sections for identifying a plurality of hair accessories based on a customer's hair color.

13. The method of claim 12, wherein the hair accessory selection device identifies the hair accessories based on a specific look the customer desires.

14. The method of claim 1, further including providing packaging for each of the hair accessories, wherein the packaging includes an area having a color that corresponds to the color of the set of which the hair accessories are a part.

15. A method of merchandising hair accessories, comprising:
providing a first set of hair accessories, wherein each of the first set of hair accessories has a first color corresponding to a brown hair color, the hair accessories including at least an elastic band and a claw clip;
providing a second set of hair accessories, wherein each of the second set of hair accessories has a second color corresponding to a blonde hair color, the hair accessories including at least an elastic band and a claw clip;
providing packaging for the hair accessories for each of the first and second set of hair accessories having a color corresponding to the color of the respective hair accessories; and
displaying the first set of hair accessories in a first section and the second set of hair accessories in a second section, wherein each one of the sections has a vertical dimension that is a greater than a horizontal dimension, and wherein the sections are arranged side-by-side.

16. The method of claim 15, further including providing a third set of hair accessories, wherein each of the third set of hair accessories has a third color corresponding to a black hair color, the hair accessories including at least an elastic band and a claw clip.

17. The method of claim 16, further including providing a fourth set of hair accessories, wherein each of the fourth set of hair accessories has a fourth color corresponding to a red hair color, the hair accessories including at least an elastic band and a claw clip.

18. The method of claim 15, wherein the elastic bands are disposed along a first horizontal axis.

19. The method of claim 17, wherein the claw clips are disposed along a second axis parallel to the first axis.

20. A system for choosing hair accessories, comprising:
a first set of hair accessories, wherein each of the first set of hair accessories are of a different type and have a first color, the first color being matched to a first hair color; and
a second set of hair accessories, wherein each of the second set of accessories are of a different type and have a second color, the second color being matched to a second hair color, and
wherein the first and second sets include a similar assortment of accessories.

21. The system of claim 20, further including a hair accessory selection device disposed adjacent at least one of the sets for identifying a plurality of hair accessories based on a customer's hair color.

22. The system of claim 20, wherein the first set of hair accessories further includes a secondary color representative of a hair treatment commonly used with the first hair color.

23. The system of claim 22, wherein the secondary color is disposed in streaks over the first color and is representative of one of highlights and lowlights.

24. The system of claim 20, wherein the first hair color and the second hair color are each matched to a hair color corresponding to colors available in commercially available hair coloring kits.

25. The system of claim 20, further including packaging for each of the hair accessories, wherein the packaging for the first set of hair accessories includes an area having the first color and the packaging for the second set of hair accessories includes an area having the second color.

26. A system of merchandising hair accessories, comprising:
a set of hair accessories, wherein each of the set of hair accessories are of a different type and have a first color, the first color being matched to a hair color; and
packaging for each accessory in the set of hair accessories, wherein the packaging includes a backing having a colored area that identifies the set of hair accessories.

27. The system of claim 26, wherein the first color and the colored area are the same color.

28. The system of claim 26, wherein the set of hair accessories includes at least two shades of the first color.

29. The system of claim 28, wherein the colored area identifies a shade of the first color and the set of hair accessories.
